(19) United States
(12) Patent Application Publication
(10) Pub. No.: US 2013/0258235 A1
(43) Pub. Date: Oct. 3, 2013

(54) WALL HANGING STRUCTURE AND CORRESPONDING LIQUID CRYSTAL DISPLAY DEVICE

(71) Applicant: Quan Li, Shenzhen (CN)

(72) Inventor: Quan Li, Shenzhen (CN)

(73) Assignee: SHENZHEN CHINA STAR OPTOELECTRONICS TECHNOLOGY CO. LTD., Shenzhen (CN)

(21) Appl. No.: 13/574,593

(22) PCT Filed: Mar. 31, 2012
(86) PCT No.: PCT/CN12/73397

§ 371 Date: Jul. 20, 2012

(30) Foreign Application Priority Data
Mar. 30, 2012 (CN) 201210090416.8

(51) Int. Cl. G02F 1/01

(52) U.S. Cl. CPC G02F 1/0102
USPC 349/58

(57) ABSTRACT

The present invention relates to a wall hanging structure and a liquid crystal display (LCD) device. The wall hanging structure comprises a plurality of side connecting portions connected with side edges of the LCD device, a back connecting portion connected with a back plate of the LCD device, and a plurality of fixing portions providing a fixing function of wall hanging. The wall hanging structure and the LCD device according to the present invention can decrease stress deformation of the back plate of the LCD device.

### FIELD OF THE INVENTION

The present invention relates to a field of display, and more particularly to a wall hanging structure of decreasing stress deformation and a corresponding liquid crystal display (LCD) device.

### BACKGROUND OF THE INVENTION

A liquid crystal display (LCD) is widely applied in various kinds of the electronic product, and more particularly in the field of LCD television (TV). Nowadays, an LCD TV (LCD device) is generally designed with a wall hanging structure to provide a fix function of wall hanging for the LCD TV. As shown in FIG. 1, a structural schematic drawing of a wall hanging structure of a traditional LCD device is illustrated in FIG. 1. The wall hanging structure 10 is assembled by four metal pillars with a wall hanging threaded hole therein riveted onto a back plate 11 of the LCD device. The corresponding LCD device is fixed on a corresponding support surface or a support rack by the metal pillars of the LCD device.

However, when the size of the LCD device trends toward larger and larger, the weight of the LCD device is also increased, gradually. Because the weight of the LCD device is too heavy, the traditional wall hanging structure is easy to cause the deformation of the back plate 11 of the LCD device, so as to influence the display quality of the LCD device. As shown in FIG. 2, a schematic drawing showing the back plate of the LCD device using the traditional wall hanging structure and deformed by the weight thereof when hanging is illustrated in FIG. 2. It can be seen in the FIG. 2, the stress of the back plate 11 mainly concentrates at the riveted metal pillars (i.e. at the wall hanging structure 10).

As a result, it is necessary to provide a wall hanging structure and a corresponding LCD device to solve the problems existing in the conventional technologies.

### SUMMARY OF THE INVENTION

The present invention provides a wall hanging structure which fixes a liquid crystal display (LCD) device by fixing the side edges and back surface of the LCD device at the same time, and provides the corresponding LCD device. It can decrease the stress deformation of the back plate of the LCD device, so as to solve the technologic problems that the conventional wall hanging structure and LCD device can not eliminate the stress deformation of the back plate of the LCD device.

The present invention relates to a wall hanging structure, which comprises: at least one side connecting portion connected with side edges of an LCD device; a back connecting portion connected with a back plate of the LCD device; and at least one fixing portion providing a fixing function of wall hanging; wherein, the side connecting portion of the wall hanging structure comprises a first side connecting portion and a second side connecting portion, wherein the first side connecting portion and the second side connecting portion are disposed at two ends of the wall hanging structure, respectively; the side connecting portions are screw-connected or rivet-connected with the side edges of the corresponding LCD device; and the back connecting portion is screw-connected or rivet-connected with the back plate of the corresponding LCD device; and the fixing portion comprises one convex portion and one wall hanging threaded hole formed on the convex portion.

The present invention relates to a wall hanging structure, which comprises: at least one side connecting portion connected with the LCD device; a back connecting portion connected with the back plate of the LCD device; and at least one fixing portion providing a fixing function of wall hanging.

In the wall hanging structure of the present invention, the wall hanging structure comprises a first side connecting portion and a second side connecting portion, wherein the first side connecting portion and the second side connecting portion are disposed at two ends of the wall hanging structure, respectively.

In the wall hanging structure of the present invention, the wall hanging structure comprises first side connecting portions, and the first side connecting portions are disposed at two ends of the wall hanging structure.

In the wall hanging structure of the present invention, the wall hanging structure comprises a first fixing portion, a second fixing portion and the back connecting portion, wherein the back connecting portion is disposed at a middle portion of the wall hanging structure; the first fixing portion is disposed between the first side connecting portion and the back connecting portion; and the second fixing portion is disposed between the second side connecting portion and the back connecting portion.

In the wall hanging structure of the present invention, the side connecting portions are screw-connected or rivet-connected with the side edges of the corresponding LCD device; and the back connecting portion is screw-connected or rivet-connected with the back plate of the corresponding LCD device.

In the wall hanging structure of the present invention, the fixing portion comprises one convex portion and one wall hanging threaded hole formed on the convex portion.

The present invention relates to an LCD device, which comprises: a display module; a back plate disposed at a back side of the display module; and at least one wall hanging structure used for hanging the LCD device; wherein the wall hanging structure comprises: at least one side connecting portion connected with side edges of the LCD device; a back connecting portion connected with a back plate of the LCD device; and at least one fixing portion providing a fixing function of wall hanging.

In the LCD device of the present invention, the wall hanging structure comprises a first side connecting portion and a second side connecting portion, wherein the first side connecting portion and the second side connecting portion are disposed at two ends of the wall hanging structure, respectively.

In the LCD device of the present invention, the wall hanging structure comprises first side connecting portions, and the first side connecting portions are disposed at two ends of the wall hanging structure.

In the LCD device of the present invention, the wall hanging structure comprises a first fixing portion, a second fixing portion and the back connecting portion, wherein the back connecting portion is disposed at a middle portion of the wall hanging structure; the first fixing portion is disposed between the first side connecting portion and the back connecting portion; and the second fixing portion is disposed between the second side connecting portion and the back connecting portion.

In the LCD device of the present invention, the side connecting portions are screw-connected or rivet-connected with the side edges of the corresponding LCD device; and the back connecting portion is screw-connected or rivet-connected with the back plate of the corresponding LCD device.

In the LCD device of the present invention, the fixing portion comprises one convex portion and one wall hanging threaded hole formed on the convex portion.

In the LCD device of the present invention, the LCD device comprises at least two wall hanging structures, wherein the wall hanging structures comprise a perpendicular wall hanging structure and/or a horizontal wall hanging structure; the perpendicular wall hanging structures is parallel to the perpendicular side edge of the LCD device; and the horizontal wall hanging structure is parallel to the horizontal side edge of the LCD device.

In the LCD device of the present invention, the LCD device comprises two perpendicular wall hanging structures or two horizontal wall hanging structures.

In the LCD device of the present invention, the LCD device comprises one perpendicular wall hanging structure and two horizontal wall hanging structures.

In the LCD device of the present invention, the LCD device comprises two perpendicular wall hanging structures and one horizontal wall hanging structure.

Hence, the advantages of carrying out the wall hanging structure and the LCD device according to the present invention are described as follows: by fixing the side edges and back surface of the LCD device at the same time, It can decrease the stress deformation of the back plate of the LCD device, so as to solve the technologic problems that the conventional wall hanging structure and LCD device can not eliminate the stress deformation of the back plate of the LCD device

For above-mention contents of the present invention can be best understood by referring to the following detailed description of the preferred embodiments and the accompanying drawings.

### DESCRIPTION OF THE DRAWINGS

FIG. 1 is a structural schematic drawing of a wall hanging structure of a traditional LCD device;

FIG. 2 is a schematic drawing showing the back plate of the LCD device using the traditional wall hanging structure and deformed by the weight thereof when hanging;

FIG. 3 is a perspective structural schematic drawing of a wall hanging structure according to a preferred embodiment of the present invention;

FIG. 4 is a structural schematic drawing of a wall hanging structure of a LCD device according to a first preferred embodiment of the present invention;

FIG. 5 is a structural schematic drawing of a wall hanging structure of a LCD device according to a second preferred embodiment of the present invention;

FIG. 6 a structural schematic drawing of a wall hanging structure of a LCD device according to a third preferred embodiment of the present invention; and

FIG. 7 is a structural schematic drawing of a wall hanging structure of a LCD device according to a fourth preferred embodiment of the present invention.

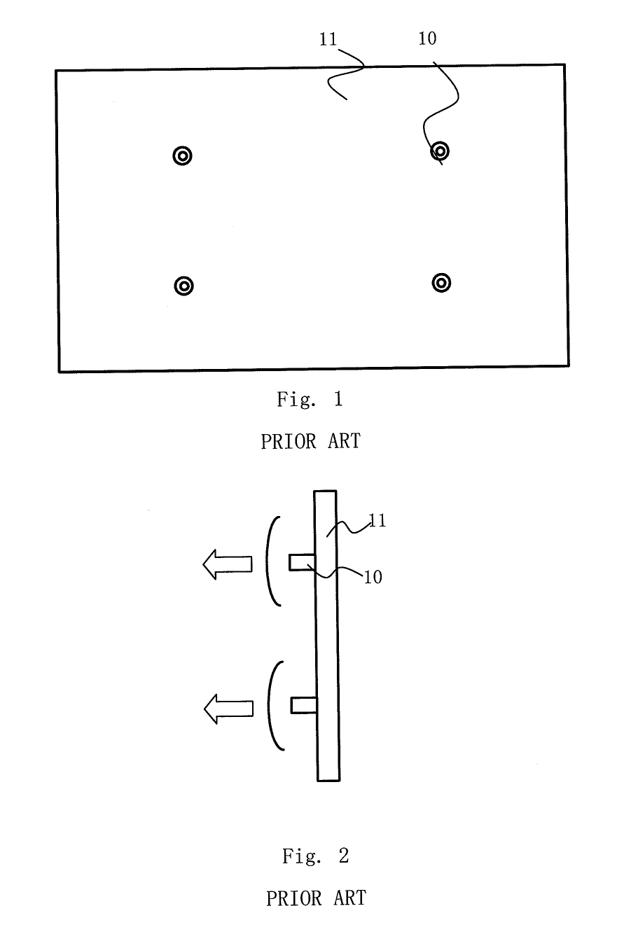

### DETAILED DESCRIPTION OF THE PREFERRED EMBODIMENTS

The description of the preferred embodiments refers to the drawings, so as to illustrate the specific embodiments of the present invention which can be carried out. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

In the drawings, the units with the similar structure use the same numerals.

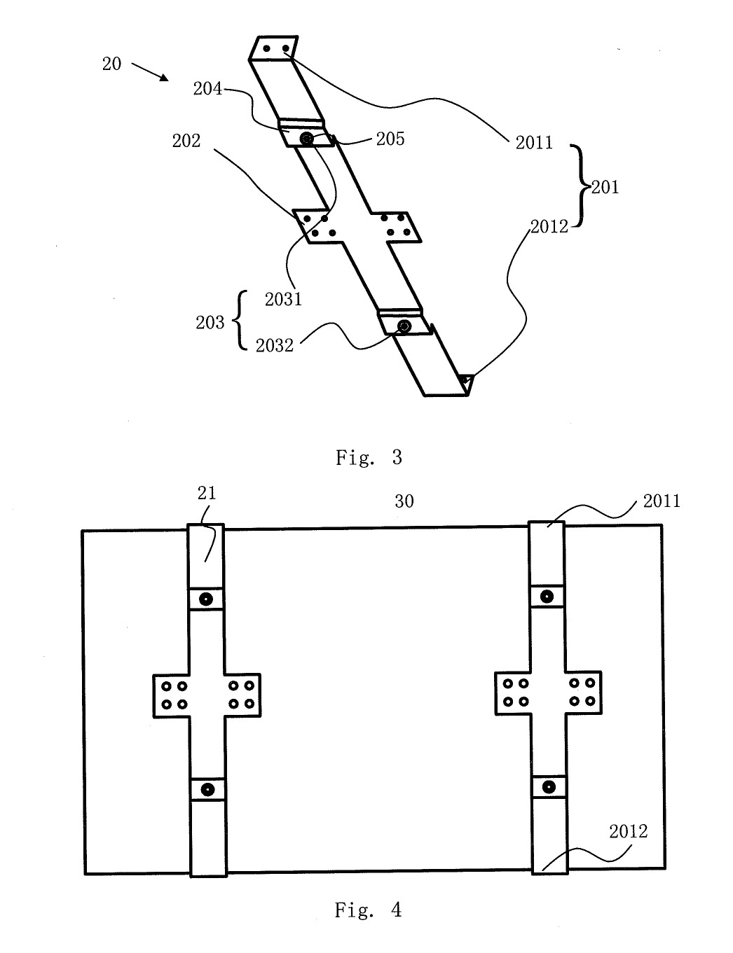

Referring now to FIG. 3, a perspective structural schematic drawing of a wall hanging structure according to a preferred embodiment of the present invention is illustrated in FIG. 3. The wall hanging structure 20 comprises two side connecting portions 201, a back connecting portion 202 and two fixing portions 203. The side connecting portions 201 are used for connecting the wall hanging structure 20 with the side edges (up-down side edges or left-right side edges) of a corresponding LCD device; the back connecting portion 202 is used for connecting the wall hanging structure 20 with a back plate of the corresponding LCD device; and the fixing portions 203 are used for providing a fixing function of wall hanging.

As shown in FIG. 3, the wall hanging structure 20 comprises a first side connecting portion 2011, a second side connecting portion 2012, a first fixing portion 2031, a second fixing portion 2032 and a back connecting portion 202.

The first side connecting portion 2011 and the second side connecting portion 2012 are disposed at two ends of the wall hanging structure 20, respectively, which are used for connecting with the side edges of the corresponding LCD device by screw-connected or rivet-connected. If the first side connecting portion 2011 connects with the up side edge of the LCD device, the second side connecting portion 2012 connects with the down side edge of the LCD device; If the first side connecting portion 2011 connects with the left side edge of the LCD device, the second side connecting portion 2012 connects with the right side edge of the LCD device. The wall hanging structure 20 according to the present invention also can be provided with only the first side connecting portion 2011 or the second side connecting portion 2012.

The back connecting portion 202 is disposed at a middle portion of the wall hanging structure 20, and is connected with a corresponding position of the back plate of the corresponding LCD device by screw-connected or rivet-connected.

The first fixing portion 2031 is disposed between the first side connecting portion 2011 and the back connecting portion 202; and the second fixing portion 2032 is disposed between the second side connecting portion 2012 and the back connecting portion 202. The first fixing portion 2031 and the second fixing portion 2032 are comprise one convex portion 204 and one wall hanging threaded hole 205 formed on the convex portion 204.

When the wall hanging structure 20 according to the present invention is in installation, firstly, to place the wall hanging structure 20 onto a corresponding position of the back plate of the corresponding LCD device; then, to connect the first side connecting portion 2011 with the up side edge of the LCD device and the second side connecting portion 2012 with the down side edge of the LCD device in order, or to connect the first side connecting portion 2011 with the left side edge of the LCD device and the second side connecting portion 2012 with the right side edge of the LCD device in order; subsequently, to connect the back connecting portion 202 with the back plate of the LCD device, so that the wall hanging structure 20 is firmly mounted onto the back plate of the LCD device. After the LCD device is assembled with the wall hanging structures 20, a wall hanging plate can be assembled through the wall hanging threaded hole 205, and then by using the wall hanging plate and fixing plate fixed on a support surface or a support rack, the LCD device is fixed on the corresponding support surface or the support rack.

When the wall hanging structure 20 according to the present invention is using on the corresponding LCD device, because the wall hanging structure 20 has the first side connecting portion 2011 and/or the second side connecting portion 2012 connected with the side edges of the LCD device, it can share a part of weight of the LCD device to the side edges of the LCD device, so as to decrease stress deformation at the riveted metal pillars by the weight thereof (if it is provided with only one side of side connecting portion, it is also can achieve the effect of decreasing the stress deformation). Meanwhile, the back connecting portion 202 can ensure that the wall hanging structure 20 is firmly connected with the back plate of the LCD device. The back connecting portion 202 can use various types of connecting methods to connect with the back plate of the LCD device, such as none-hole machine rivet, so as to effectively lower the assembly cost. According to the requirement, the side connecting portions 201 also can use various types of connecting methods to connect with the side edges of the LCD device. The convex portion 204 can make the corresponding component without impact damage for the back plate of the LCD device when the LCD device is mounted on the wall hanging plate through the wall hanging threaded hole 205.

The present invention further relates to a LCD device, as show in FIGS. 3 and 4, wherein the LCD device comprises a display module, a back plate 30 and at least one wall hanging structure 20. The display module is used for displaying images; the back plate 30 is disposed at the back side of the display module used for protect the display module; and the wall hanging structure 20 is used for hanging the LCD device. The wall hanging structure 20 comprises two side connecting portions 201, a back connecting portion 202 and two fixing portions 203. The side connecting portions 201 are used for connecting the wall hanging structure 20 with side edges (up-down side edges or left-right side edges) of a corresponding LCD device; the back connecting portion 202 is used for connecting the wall hanging structure 20 with the back plate of the corresponding LCD device; and the fixing portions 203 are used for providing a fixing function of wall hanging. The specific structure and beneficial effect of the wall hanging structure 20 are described as above-mentioned specific embodiment of the wall hanging structure 20, so please referring to the corresponding specific embodiment of the wall hanging structure 20.

The LCD device according to the present invention comprises at least two wall hanging structures 20, and the wall hanging structures 20 comprise at least one perpendicular wall hanging structure 21 and/or at least one horizontal wall hanging structure 22. The perpendicular wall hanging structures 21 is parallel to the perpendicular side edge of the LCD device; and the horizontal wall hanging structure 21 is parallel to the horizontal side edge of the LCD device. The LCD device according to the present invention can only use the perpendicular wall hanging structures 21, or only use the horizontal wall hanging structures 22. Of course, it can both use the perpendicular wall hanging structures 21 and the horizontal wall hanging structures 22 at the same time. The specific structure of it refers the specific embodiments as follows.

As shown in FIG. 4, a structural schematic drawing of a wall hanging structure of a LCD device according to a first preferred embodiment of the present invention is illustrated in FIG. 4. The LCD device comprises two perpendicular wall hanging structures 21. The first side connecting portion 2011 and the second side connecting portion 2012 of the perpendicular wall hanging structures 21 are screw-connected or rivet-connected with the horizontal side edge of the LCD device, respectively, so it can share a part of weight of the LCD device to the horizontal side edges of the LCD device, so as to prevent the back plate of the LCD device from stress deformation.

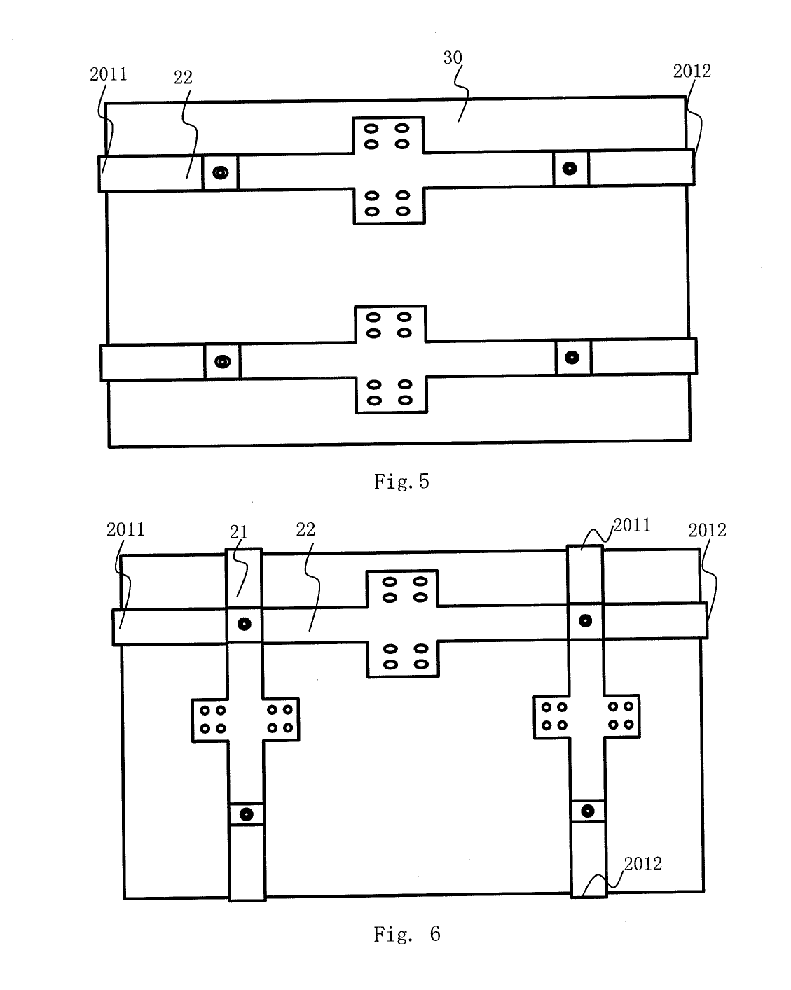

As shown in FIG. 5, a structural schematic drawing of a wall hanging structure of a LCD device according to a second preferred embodiment of the present invention is illustrated in FIG. 5. The LCD device comprises two horizontal wall hanging structures 22. The first side connecting portion 2011 and the second side connecting portion 2012 of the horizontal wall hanging structures 22 are screw-connected or rivet-connected with the perpendicular side edge of the LCD device, respectively, so it can share a part of weight of the LCD device to the perpendicular side edges of the LCD device, so as to prevent the back plate of the LCD device from stress deformation.

As shown in FIG. 6, a structural schematic drawing of a wall hanging structure of a LCD device according to a third preferred embodiment of the present invention is illustrated in FIG. 6. The LCD device comprises two perpendicular wall hanging structures 21 and one horizontal wall hanging structure 22, wherein the first side connecting portion 2011 and the second side connecting portion 2012 of the horizontal wall hanging structures 22 are screw-connected or rivet-connected with the perpendicular side edge of the LCD device, respectively, and the first side connecting portion 2011 and the second side connecting portion 2012 of the perpendicular wall hanging structures 21 are screw-connected or rivet-connected with the horizontal side edge of the LCD device, respectively. Because, the position of the fixing portions 203 of the wall hanging structures 20 with the same type of LCD device are constant, each of the perpendicular wall hanging structure 21 can decrease one of the fixing portions 203, so that the wall hanging structures 20 of the LCD device are still has four fixing portions 203, and the position of the fixing portions 203 are the same as the fixing portions 203 above-mentioned.

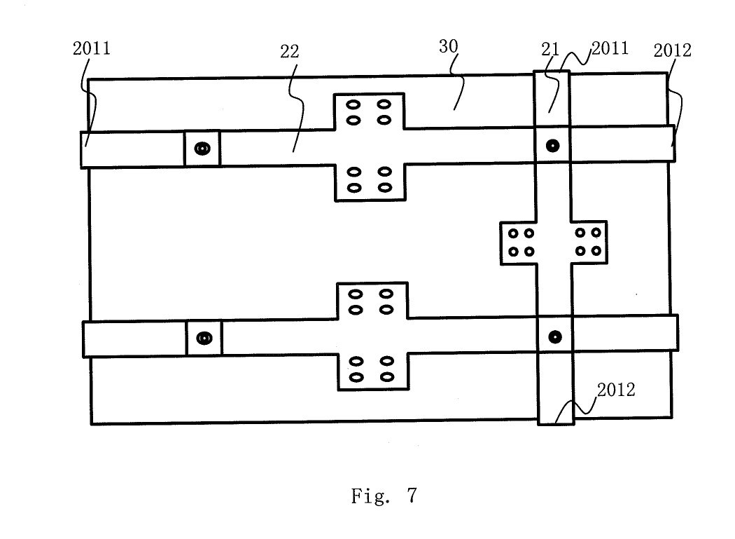

As shown in FIG. 7, a structural schematic drawing of a wall hanging structure of a LCD device according to a fourth preferred embodiment of the present invention is illustrated in FIG. 7. The LCD device comprises two horizontal wall hanging structures 22 and one perpendicular wall hanging structure 21, wherein the first side connecting portion 2011 and the second side connecting portion 2012 of the horizontal wall hanging structures 22 are screw-connected or rivet-connected with the perpendicular side edge of the LCD device, respectively, and the first side connecting portion 2011 and the second side connecting portion 2012 of the perpendicular wall hanging structure 21 are screw-connected or rivet-connected with the horizontal side edge of the LCD device, respectively. Because, the position of the fixing portions 203 of the wall hanging structures 20 with the same type of LCD device are constant, each of the horizontal wall hanging structures 22 can decrease one of the fixing portions 203, so that the wall hanging structures 20 of the LCD device are still has four fixing portions 203, and the position of the fixing portions 203 are the same as the fixing portions 203 above-mentioned.

According to requirement, the count of the wall hanging structures 20 (the perpendicular wall hanging structure 21 and/or horizontal wall hanging structures 22) used in the LCD device of the present invention can be increase or decrease (such as using two perpendicular wall hanging structures 21 and two horizontal wall hanging structures 22), and it is not limited in preferred embodiments above-mentioned. Preferably, the positions of the fixing portions 203 are the same as the fixing portions 203 of the wall hanging structures 20 of the LCD device above-mentioned.

Hence, by efficiently sharing a part of weight of the LCD device to the side edges of the LCD device through the side connecting portions of the wall hanging structures, the wall hanging structures and the LCD device according to the present invention can improve the mechanical strength of the wall hanging structures of the LCD device, and decrease the stress deformation of the back plate of the LCD device, so as to decrease the influence to the display quality of the LCD device.

As described above, the present invention has been described with a preferred embodiment thereof and it is understood that many changes and modifications to the described embodiment can be carried out without departing from the scope and the spirit of the invention that is intended to be limited only by the appended claims.

1. A wall hanging structure, comprising:
at least one side connecting portion connected with side edges of a liquid crystal display (LCD) device;
a back connecting portion connected with a back plate of the LCD device; and
at least one fixing portion providing a fixing function of wall hanging;
wherein the side connecting portion of the wall hanging structure comprises a first side connecting portion and a second side connecting portion, wherein the first side connecting portion and the second side connecting portion are disposed at two ends of the wall hanging structure, respectively;
wherein the side connecting portions are screw-connected or rivet-connected with the side edges of the corresponding LCD device; and the back connecting portion is screw-connected or rivet-connected with the back plate of the corresponding LCD device; and
wherein the fixing portion comprises one convex portion and one wall hanging threaded hole formed on the convex portion.

2. A wall hanging structure, comprising:
at least one side connecting portion connected with side edges of an LCD device;
a back connecting portion connected with a back plate of the LCD device; and
at least one fixing portion providing a fixing function of wall hanging.

3. The wall hanging structure according to claim 2, wherein the wall hanging structure comprises a first side connecting portion and a second side connecting portion, wherein the first side connecting portion and the second side connecting portion are disposed at two ends of the wall hanging structure, respectively.

4. The wall hanging structure according to claim 2, wherein the wall hanging structure comprises first side connecting portions, and the first side connecting portions are disposed at two ends of the wall hanging structure.

5. The wall hanging structure according to claim 3, wherein the wall hanging structure comprises a first fixing portion, a second fixing portion and the back connecting portion, wherein the back connecting portion is disposed at a middle portion of the wall hanging structure; the first fixing portion is disposed between the first side connecting portion and the back connecting portion; and the second fixing portion is disposed between the second side connecting portion and the back connecting portion.

6. The wall hanging structure according to claim 2, wherein the side connecting portions are screw-connected or rivet-connected with the side edges of the corresponding LCD device; and the back connecting portion is screw-connected or rivet-connected with the back plate of the corresponding LCD device.

7. The wall hanging structure according to claim 2, wherein the fixing portion comprises one convex portion and one wall hanging threaded hole formed on the convex portion.

8. An LCD device, comprising:
a display module;
a back plate disposed at a back side of the display module; and
at least one wall hanging structure to hang the LCD device;
wherein the wall hanging structure comprises:
at least one side connecting portion connected with side edges of the LCD device;
a back connecting portion connected with the back plate of the LCD device; and
at least one fixing portion providing a fixing function of wall hanging.

9. The LCD device according to claim 8, wherein the wall hanging structure comprises a first side connecting portion and a second side connecting portion, wherein the first side connecting portion and the second side connecting portion are disposed at two ends of the wall hanging structure, respectively.

10. The LCD device according to claim 8, wherein the wall hanging structure comprises first side connecting portions, and the first side connecting portions are disposed at two ends of the wall hanging structure.

11. The LCD device according to claim 9, wherein the wall hanging structure comprises a first fixing portion, a second fixing portion and the back connecting portion, wherein the back connecting portion is disposed at a middle portion of the wall hanging structure; the first fixing portion is disposed between the first side connecting portion and the back connecting portion; and the second fixing portion is disposed between the second side connecting portion and the back connecting portion.

12. The LCD device according to claim 8, wherein the side connecting portions are screw-connected or rivet-connected with the side edges of the corresponding LCD device; and the back connecting portion is screw-connected or rivet-connected with the back plate of the corresponding LCD device.

13. The LCD device according to claim 8, wherein the fixing portion comprises one convex portion and one wall hanging threaded hole formed on the convex portion.

14. The LCD device according to claim 8, wherein the LCD device comprises at least two of the wall hanging structures, wherein the wall hanging structures comprise a perpendicular wall hanging structure and a horizontal wall hanging structure; the perpendicular wall hanging structure is parallel to a perpendicular side edge of the LCD device; and the horizontal wall hanging structure is parallel to a horizontal side edge of the LCD device.

15. The LCD device according to claim 8, wherein the LCD device comprises two perpendicular wall hanging structures or two horizontal wall hanging structures.

16. The LCD device according to claim 8, wherein the LCD device comprises one perpendicular wall hanging structure and two horizontal wall hanging structures.

17. The LCD device according to claim 8, wherein the LCD device comprises two perpendicular wall hanging structures and one horizontal wall hanging structure.
